(19) United States
(12) Patent Application Publication
(10) Pub. No.: US 2012/0222340 A1
(43) Pub. Date: Sep. 6, 2012

(54) SOLAR RECHARGEABLE SELF ILLUMINATED TAG

(76) Inventors: Pierre Paquette, Montreal (CA); Amina Remati, Montreal (CA); Lynda Amghar, La Prairie (CA); Patrick Cameron, La Prairie (CA)

(21) Appl. No.: 13/040,182

(22) Filed: Mar. 3, 2011

(51) Int. Cl. G09F 13/00

(52) U.S. Cl. 40/541

(57) ABSTRACT

A self illuminated display board attached to a transparent material, like a window. The board contains a message or logo or picture illuminated by one or more light sources. When lighting conditions are strong, a solar panel tied to the main board recharge an energy storage device. When lighting conditions are low, the energy storage device powers the light source.

### BACKGROUND OF THE INVENTION:

The present invention generally relates to brand, logo or message advertising. These kinds of messages have been around for many years, that stick inside cars windows, houses windows etc. For example, alarm systems companies provide printed stickers that glue indoor side of windows to warn burglars about the security system. The purpose is also promotion since they print their brand, phone number or logo on the label. Same idea for “BABY ON BOARD” signs inside cars.

However, these conventional labels are mostly difficult to read when environment becomes darker. Accordingly, there is a need for an illuminated tag that provides better eyes catching attention, that not rely on power grid, to ease customer acceptance and simplify installation at many locations. Other features and applications are possible. By using different electronic circuits, board shapes and light sources, this tag can be used for Christmas decorations, Halloween displays, movies and TV characters or brand names promotions. Multicolour light sources, with or without blinking rates, can provide improved eye catching attention. These lighting activities can be managed from a microprocessor, triggered from the light sensor, or a vibration sensor integrated on the electronic circuit (like installation to a door's window with “NO SOLICITING PLEASE” message). Other triggering devices can be a manual switch, or an infrared remote control, or sound. The complete assembly uses the actual reflection from the transparent surface it is attached to, in a way that improves surface visibility.

### BRIEF DESCRIPTION OF THE DRAWINGS:

The accompanying drawings illustrate the invention. In such drawings:

FIG. 1 is a side cross-section elevation view;

FIG. 2 is a front view of the present invention.

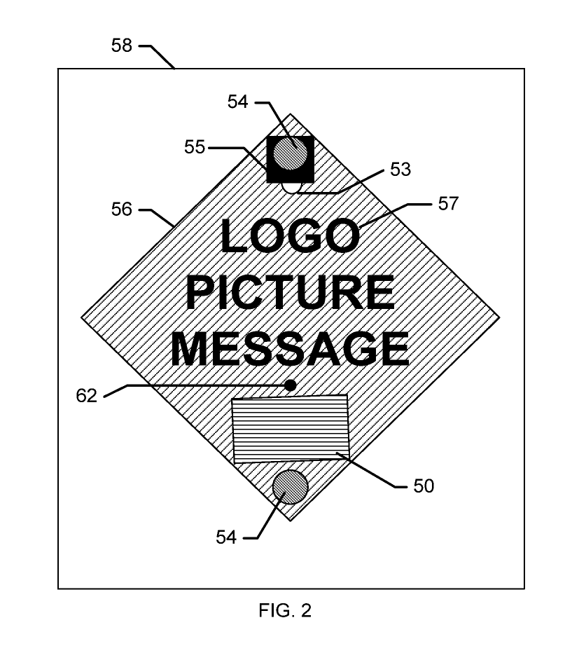

### DETAILED DESCRIPTION OF THE PREFERRED EMBODIMENT:

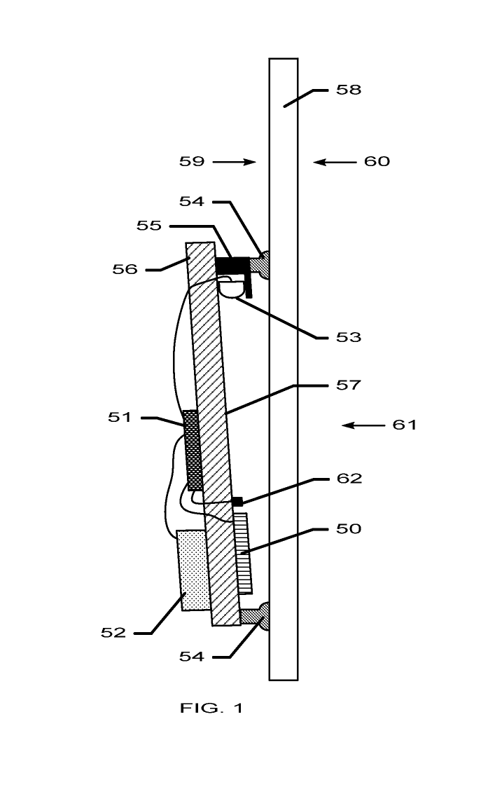

As shown in the drawings for purpose of illustration, the present invention resides on a main board that includes a solar rechargeable self illuminated message attached to a transparent surface. With reference to FIG. 1, a main board 56, with a message on its surface 57, can be viewed thru a transparent surface 58 from the other side 61. The transparent material 58 can be part of a building, car, boat or any kind of enclosure; the transparent material 58 is not part of the invention but the structure where the invention is attached to. Attachment to the transparent material is done by suction disks 54 or glue or other mechanical devices. The light source(s) 53 is located on the main board 56. A light shield 55 prevents direct view of the light source from outside 61. The light shield 55 also act as a spacer giving the main board an angle from the transparent material 58; This angle permits better surface illumination of the surface by redirecting light emitted by the light source 53 and minimizing “dark spots”.

A light sensor 62 detects when natural lighting conditions are low; then an electronic circuit 51 activates the light source 53 by the energy storage device 52. A solar panel 50 comprised of one or more solar cells for generating electricity is located on the main board 56 and exposed to external light 61. When light hits the solar panel 50 and provides enough energy, current is transferred by the electronic circuit 51 to the storage device 52. Although an embodiment has been described in detail for purpose of illustration, various shapes may be made without departing from the scope and spirit of the invention.

What is claimed is:

1. An illuminated tag, comprising:
a main board, with a message, logo, picture or the like;
a light source that illuminate the main board surface;
a means for attachment of the main board to a transparent material;
a solar panel for generating electricity, tied to the main board;
an energy storage device tied to the main board;
an electronic circuit for energy storage and light source management.

2. The tag of claim 1, including a light shield.

3. The tag of claim 1, including spacers helping to achieve better illumination from light reflection from the transparent material.

4. The tag of claim 1, including a light measurement sensor.

5. The tag of claim 1, including a vibration sensor.

6. The tag of claim 1, including a colour light source.

7. The tag of claim 1, including multicolour light source.

8. The tag of claim 1, including multiple lights sources.

9. The tag of claim 1, including a microprocessor for managing energy storage and light source.

10. The tag of claim 1, including a microprocessor for managing light source colors.

11. The tag of claim 1, including a microprocessor for managing light source according to lighting measurement.

12. The tag of claim 1, including a microprocessor for managing light source according to vibration detection.

13. The tag of claim 1, including a manual switch to trigger operation.

14. The tag of claim 1, including a remote control to trigger operation.

15. The tag of claim 1, including a microphone to trigger operation.

16. The tag of claim 1, including a temperature sensor to trigger operation.
